(19) United States
(12) Patent Application Publication
(10) Pub. No.: US 2024/0118936 A1
(43) Pub. Date: Apr. 11, 2024

(54) PERFORMANCE-ENHANCED HARDWARE ACCESS SCHEDULING

(71) Applicant: Meta Platforms Technologies, LLC, Menlo Park, CA (US)

(72) Inventors: Linda Cheng, San Jose, CA (US); Feng Wei, San Jose, CA (US)

(21) Appl. No.: 18/193,063

(22) Filed: Mar. 30, 2023

Related U.S. Application Data
(60) Provisional application No. 63/378,941, filed on Oct. 10, 2022.

(51) Int. Cl. G06F 9/50; G06F 9/48

(52) U.S. Cl. CPC G06F 9/5044; G06F 9/4881

(57) ABSTRACT

In one embodiment, a method by an arbiter associated with hardware resources of a computing system includes associating with N indexed requesters requesting accesses to the hardware resources, where each of the N indexed requesters is associated with a credit counter and a weight, repeatedly granting a right to access the hardware resources to each requester that satisfies conditions in an indexing order among the N indexed requesters until none of the N indexed requesters satisfies the conditions and replenishing, upon a determination that none of the N indexed requesters satisfies the conditions, a credit counter associated with each of the N indexed requesters.

### PRIORITY

This application claims the benefit under 35 U.S.C. § 119(e) of U.S. Provisional Patent Application No. 63/378,941, filed 10 Oct. 2022, which is incorporated herein by reference.

### TECHNICAL FIELD

This disclosure generally relates to computing hardware systems, and in particular, related to scheduling hardware accesses by an arbiter.

### BACKGROUND

An Arbiter in a computing system may be used to provide access of hardware resources when a plurality of requesters are competing for the hardware resources. For example, a System-on-Chip (SoC) may compromise various hardware units on a single chip. In SoC, data transfer between different units may take place via single bus. The bus may need to be assigned to a single hardware unit at a particular time to remove ambiguity while a plurality of hardware units are competing for the data bus. The plurality of hardware units may be referred to as requesters. The bus may be an example of hardware resources.

### SUMMARY OF PARTICULAR EMBODIMENTS

Particular embodiments described herein relate to systems and methods for scheduling hardware accesses between a plurality of competing requesters. In high performing hardware systems, an arbiter may be used to fairly select one winner among a plurality of competing requesters. A number of different arbiters, such as round robin (RR) arbiters, weighted round robin (WRR) arbiters, and deficit weighted round robin (DWRR) arbiters, have been used for scheduling hardware accesses. A desired arbiter for high performance computing systems may have a few requirements: The arbiter may ensure long term fairness. The arbiter may allow for variable sized bursts. The arbiter may define weights to proportion traffic with sufficient granularity. The arbiter may be easy to implement. The arbiter may be able to schedule an access as soon as a request arrives. The arbiter may be able to rotate between requesters as evenly as possible. None of the existing arbiters may fulfill those requirements. The arbiter disclosed herein may satisfy all the requirements addressed above.

In particular embodiments, an arbiter associated with hardware resources of a computing system may be associated with N indexed requesters requesting accesses to the hardware resources. Each of the N indexed requesters may be associated with a credit counter and a weight. The arbiter may repeatedly grant a right to access the hardware resources to each requester that satisfies conditions in an indexing order among the N indexed requesters until none of the N indexed requesters satisfies the conditions. The conditions may comprise (1) the requester having an access request requiring a first number of credits at a head of a queue associated with the requester, and (2) a second number of credits available at a credit counter associated with the requester being greater or equal to the first number of credits.

In particular embodiments, the arbiter may perform the following steps for each grant. At a first step, the arbiter may identify a next requester that has an access request to the hardware resource at a head of a queue associated with the next requester. To identify the next request, the arbiter may repeat updating a current index value and determining whether a requester corresponding to the current index value satisfies the conditions until a requester corresponding to the current index value satisfies the conditions. In particular embodiments, updating the current index value may comprise increasing the current index value by one. When the arbiter determines that the current index value is greater than an index value corresponding to a last indexed requester among the N indexed requesters, the arbiter may reset the current index value to an index value corresponding to a first indexed requester among the N indexed requesters. At a second step, the arbiter may update the credit counter associated with the next requester by subtracting the first number corresponding to a number of credits required by the access request from the second number corresponding to a number of credits available at the credit counter. At a third step, the arbiter may grant the next requester to access the hardware resources for a number of credits associated with the access request.

When the arbiter determines that none of the N indexed requesters satisfies the conditions, the arbiter may replenish a credit counter associated with each of the N indexed requesters. In particular embodiments, replenishing a credit counter associated with a requester may comprise adding the weight corresponding to the requester to the credit counter when the arbiter determines that the requester has one or more access requests in a queue associated with the requester. In particular embodiments, replenishing a credit counter associated with a requester may comprise resetting the credit counter to the weight corresponding to the requester when the arbiter determines that the requester has zero access request in a queue associated with the requester.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a table representing an example situation for a WRR arbiter.

FIG. 1B illustrates example transmissions of packets scheduled by a WRR arbiter.

FIG. 2 illustrates an example logical architecture for an enhanced DWRR arbiter.

FIG. 3A illustrates a table representing an example situation for a comparison between a legacy DWRR arbiter and an enhanced DWRR arbiter.

FIG. 3B illustrates an example behavior of a legacy DWRR arbiter for the given situation.

FIG. 3C illustrates an example behavior of an enhanced DWRR arbiter for the given situation.

FIG. 4 illustrates an example behavior of an enhanced DWRR arbiter in detail.

FIG. 5 illustrates an example method for scheduling hardware accesses between a plurality of competing requesters.

FIG. 6 illustrates an example computer system.

### DESCRIPTION OF EXAMPLE EMBODIMENTS

In high performing hardware systems, an arbiter may be needed to fairly select one winner among a plurality of competing requesters. A most basic arbiter may be a round robin arbiter. A round robin arbiter may grant requestors with equal priority in a rotating manner. The round robin arbiter may work well where all the requestors are asking for equal amount of access to the shared hardware resources. An enhancement to the round robin arbiter may be a weighted round robin (WRR) arbiter. The WRR arbiter may add the configurability to weight the ratio of wins amongst the different requestors. For example, when requestors A, B and C have weights 3:2:1, requestor A gets a half the share of resources, while requester B gets one third and requester C gets one sixth, assuming A, B and C constantly compete for the resource. WRR is a solution that still falls short when the size of the request varies per requestor and over time. As an example and not by way of limitation, packets in a switched network may have varying lengths. An WRR arbiter may only weight the number of grants per requestor. The WRR arbiter may not consider the size of the grants. In the application of variable sized requests, a large request should not have equal weight as a small request. Otherwise, a requestor with large requests may gain access to a disproportionate amount of the available resources compared to a requestor with small requests.

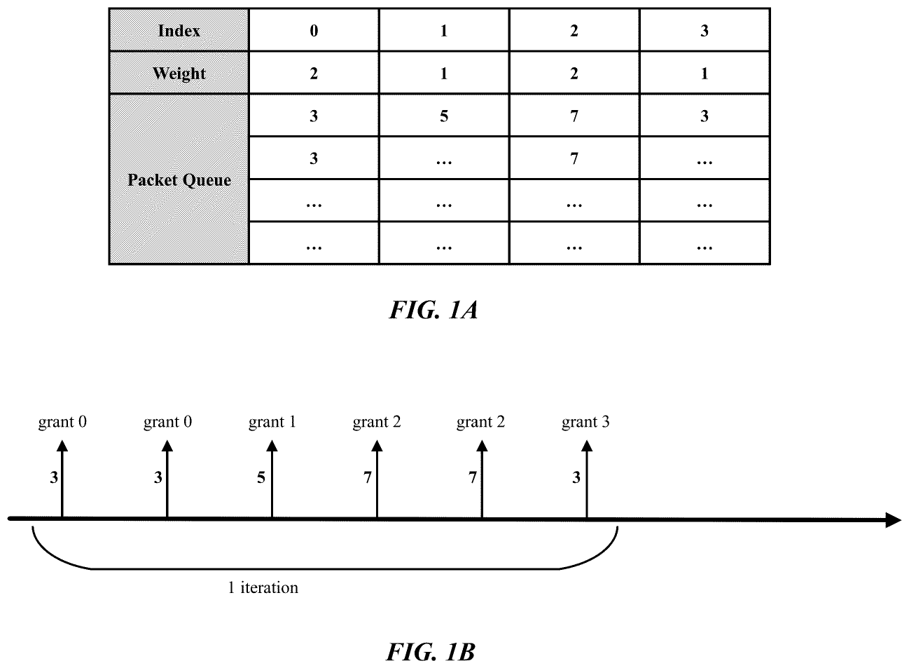

FIG. 1A illustrates a table representing an example situation for a WRR arbiter. Each of four requesters, indexed 0, 1, 2, and 3, has a packet queue, in which zero or more packets to transmit are waiting to be transmitted. In the example illustrated in FIG. 1A, requester 0 has at least two packets in the queue, the size of each is 3. Requester 1 has at least one packet in the queue, the size of which is 5. Requester 2 has at least two packets in the queue, each of which has size 7. Requester 3 has at least one packet in the queue, the size of which is 3. Weights assigned to the requesters are 2, 1, 2, and 1, respectively. FIG. 1B illustrates example transmissions of packets scheduled by a WRR arbiter. Because the weight assigned to requester 0 is 2, the first two packets of size 3 from the queue are scheduled for transmissions in an iteration. As the weight assigned to requester 1 is 1, the first packet of size 5 from the queue is scheduled for a transmission in the iteration. As the weight assigned to requester 2 is 2, the first two packets of size 7 are scheduled for transmissions in the iteration. As the weight assigned to requester 3, is 1, the first packet of size 3 is scheduled for a transmission in the iteration. While the weights assigned to the requesters are 2, 1, 2, and 1, actual transmission resources allocated to the requesters are 6, 5, 14, and 3. The example illustrated in FIGS. 1A and 1B shows that the WRR arbiter may fail to schedule accesses to hardware resources proportional to assigned weights when the size of the access requests varies.

Deficit Weighted Round Robin (DWRR), an alternative to WRR, may be a solution that provides weighting per requestor but also considers the size of the access requests. However, a DWRR arbiter may not be ideal for high performance hardware systems. A legacy DWRR arbiter may look at all the requesters with non-empty queues. When credit counter values for the requesters are replenished, a credit counter value for each requester with non-empty queue may bump up by a ‘quantum’ amount. The ‘quantum’ is a weight assigned to the requester. When a number of credits required for an access request at the head of the queue for a requester is less than or equal to a number of credits available at the credit counter associated with the requester, the requester is allowed to compete with other qualified requestors in the arbitration. Each granted access may decrement the credit counter by the number of credits required for the access. If one requester wins, a number of access requests from the requestor may get granted until the credits available at the credit counter becomes not enough for the next access request at the head of the queue. If the queue is empty for a requester, the credit counter for the requester is set to zero. The scheduler may move to service the next requester with a non-empty queue. When the credit counters are replenished, the credit counter value for a requester with non-empty queue may get increased for the weight assigned for the requester, while the credit counter value for a requester with empty queue may remain zero.

An ideal arbiter for high performance computing systems may have a few requirements as followings:
1. ensures long term fairness.
2. allows for variable sized bursts.
3. defines weights to proportion request size with sufficient granularity.
4. is easy to implement.
5. can access the hardware resources as soon as a request arrives.
6. rotates between requesters as evenly as possible.

The legacy DWRR arbiter may fail to fulfill the last two requirements. Regarding item 5, the legacy DWRR arbiter may need at least one clock delay every time an access request arrives at an empty queue because the credit counter has zero credit when the queue is empty. Thus, the access request may take at least one clock cycle to replenish the credit counter value, which may affect the latency of high-performance computing systems in a significant way. Because a high-performance computing system may have up to 15 arbitration points in the network between a source and a destination, the DWRR arbiter may cause an extraneous 15 clocks of extra latency.

Regarding item 6, the legacy DWRR arbiter may grant a plurality of accesses to a requester until its credit counter runs out of credits. This feature may hinder the support for real-time traffic and any other traffic requiring low jitter. While one requestor is monopolizing the hardware resources for a long time, the other requesters may be shut out. An enhanced DWRR arbiter disclosed herein may satisfy all the aforementioned requirements for an ideal arbiter for high performance computing systems.

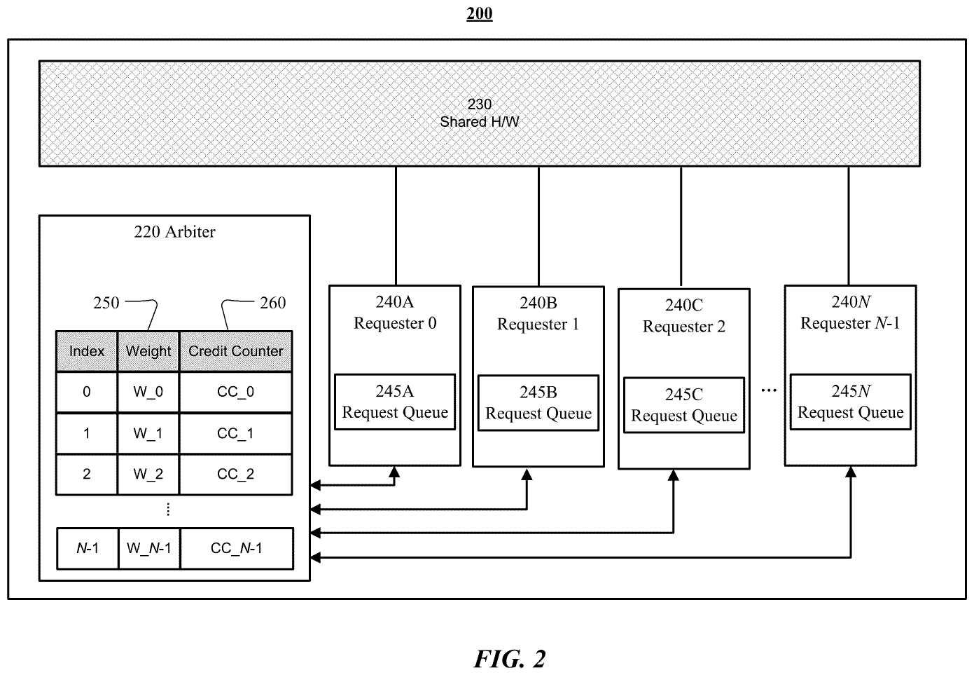

FIG. 2 illustrates an example logical architecture for an enhanced DWRR arbiter within a computing system. A computing system 200 may have shared hardware resources 230 that may be shared by N requesters, 240A, 240B, 240C, . . . , 240N. Each of the requesters 240A, 240B, 240C, and 240N may have a request queue 245A, 245B, 245C, . . . , 245N. An arbiter 220 may schedule accesses to the shared hardware resources 230 between the requesters 240A, 240B, 240C, and 240N. The arbiter 220 may be configured to manage a weight 250 associated with each requester 240A, 240B, 240C, and 240N. The arbiter 220 may also maintain a credit counter 260 for each requester 240A, 240B, 240C, and 240N. The request queue 245 may have zero or more access requests. Each access request may be of a corresponding size. A typical access request may be a packet. A typical shared hardware resources 230 may be a packet transmitter. Although this disclosure describes a particular logical architecture for an arbiter, this disclosure contemplates any suitable logical architecture for an arbiter.

In particular embodiments, an arbiter 220 associated with hardware resources 230 of a computing system 200 may be associated with N indexed requesters 240A, 240B, 240C, and 240N requesting accesses to the hardware resources 230. Each of the N indexed requesters 240A, 240B, 240C, and 240N may be associated with a credit counter 260 and a weight 250.

In particular embodiments, the arbiter 220 may repeatedly grant a right to access the hardware resources 230 to each requester that satisfies conditions in an indexing order among the N indexed requesters 240A, 240B, 240C, and 240N until none of the N indexed requesters 240A, 240B, 240C, and 240N satisfies the conditions. After granting an access to a first requestor, the arbiter 220 may select a new winner even when if the first requester still has enough credit to continue to access the hardware resources 230. A refresh of credits may not happen until all active requestors are out of credit, which may significantly lengthen the time between credit refreshes. With the legacy DWRR, a refresh may happen after the arbiter has cycled through N requestors, allowing each to send if they have enough credit. Thus, a requestor is given a single chance to send per iteration. With the enhanced arbiter 220, a requestor may get multiple chances to send. The arbiter 220 may circle through the N indexed requestors a number of times before credit for all active requestors is exhausted. Although this disclosure describes granting access rights to requesters in a particular manner, this disclosure contemplates granting access rights to requesters in any suitable manner.

In particular embodiments, the conditions may comprise (1) the requester having an access request requiring a first number of credits at a head of a queue associated with the requester, and (2) a second number of credits available at a credit counter associated with the requester being greater or equal to the first number of credits. As an example and not by way of limitation, a packet of size 5 exists at the head of the queue 245A associated with the first requester 240A. And the credit counter 260 associated with the first requester 240A has 10 remaining credits. The first requester 240A satisfies the conditions. As another example and not by way of limitation, a packet of size 11 exists at the head of the queue 245B associated with the second requester 240B. The credit counter 260 associated with the second requester 240C has 9 remaining credits. Then, the second requester 240B does not satisfy the conditions because the first number of credits required by the access request (packet) is greater than the second number of credits available at the credit counter associated with the second requester 240B. As yet another example and not by way of limitation, the queue 245C associated with the third requester 240C is empty. Then, the third requester 240C fails to satisfy the conditions. Although this disclosure describes particular conditions to be eligible to access hardware resources, this disclosure contemplates any suitable conditions to be eligible to access hardware resources.

In particular embodiments, the arbiter 220, for each grant, may identify a next requester that has an access request to the hardware resource at a head of a queue associated with the next requester. The arbiter 220 may update the credit counter 260 associated with the next requester by subtracting the first number corresponding to a number of credits required by the access request from the second number corresponding to a number of credits available at the credit counter 260. The arbiter 220 may grant the next requester to access the hardware resources 230 for a number of credits associated with the access request. Although this disclosure describes granting a requester to access hardware resources in a particular manner, this disclosure contemplates granting a requester to access hardware resources in any suitable manner.

In particular embodiments, to identify the next request, the arbiter 220 may repeat updating a current index value and determining whether a requester corresponding to the current index value satisfies the conditions until a requester corresponding to the current index value satisfies the conditions. In particular embodiments, updating the current index value may comprise increasing the current index value by one. When the arbiter 220 determines that the current index value is greater than an index value corresponding to a last indexed requester 240N among the N indexed requesters, the arbiter 220 may reset the current index value to an index value corresponding to a first indexed requester 240A among the N indexed requesters.

When the arbiter 220 determines that none of the N indexed requesters satisfies the conditions, the arbiter 220 may replenish a credit counter 260 associated with each of the N indexed requesters 240A, 240B, 240C, and 240N. In particular embodiments, replenishing a credit counter 260 associated with a requester may comprise adding the weight 250 corresponding to the requester to the credit counter 260 when the arbiter 220 determines that the requester has one or more access requests in a queue associated with the requester. In particular embodiments, replenishing a credit counter 260 associated with a requester may comprise resetting the credit counter 260 to the weight 250 corresponding to the requester when the arbiter 220 determines that the requester has zero access request in a queue associated with the requester. Rather than accumulating credits after an access request arrives, a credit for a requestor with an empty queue may be the quantum number of credits, which may allow a packet to be able to immediately utilize credit upon arrival and be able to win an arbitration without the delay of waiting at least one cycle to accrue the needed credit. As an example and not by way of limitation, a requester is associated a weight of 8. If a write burst varies in length from 1 to 8, any write burst may be able to be selected by the arbiter immediately after its arrival. With a legacy DWRR arbiter, a credit counter value for a requester may be zero when a packet arrives to an empty packet. The packet may need to wait at least one clock cycle. In summary, with the legacy DWRR arbiter, credits revert to zero when a requestor is not requesting, but with the enhanced DWRR arbiter, credits revert to the quantum/weight. Although this disclosure describes replenish credit counters associated with the requesters in a particular manner, this disclosure contemplates replenish credit counters associated with the requesters in any suitable manner.

In particular embodiments, the enhanced DWRR arbiter 220 may allow the traffic for any requestor to arrive in a burstier fashion, but still to participate in the running iteration. The enhanced DWRR arbiter 220 may have a longer iteration between replenishing credits compared with the legacy DWRR arbiter. The longer iteration may provide the requestors multiple chances to utilize the credit. A wider window to use credit may lead to better fairness because the requestors have more chances to use all of its credit rather than losing its opportunity as soon as its queue drains. An iteration that ends when all the credits are drained may result in the outcome that is desired based on the architected weights. With the legacy DWRR arbiter, iterations may end prematurely if traffic arrives in a bursty manner.

Another obvious benefit of the enhanced DWRR arbiter 220 may be that the transmission of data is smoother. With legacy DWRR, the traffic pattern with requestors a, b, c is AAAAABBBCC. With the enhanced DWRR arbiter 220, the traffic pattern may be ABACABACABA. This traffic pattern may help targets with a fixed processing rate for packets A, B or C to keep busy. The targets may neither be starved nor overwhelmed but may be kept busy continuously when traffic arrives smoothly.

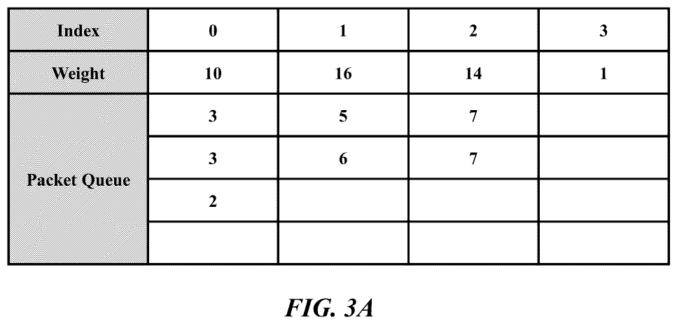

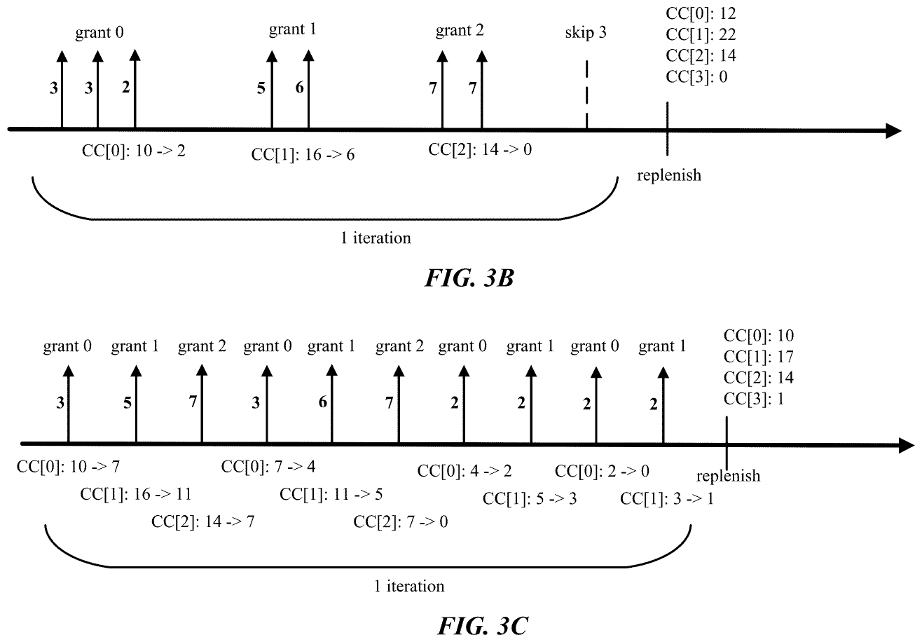

FIGS. 3A-3C illustrate a comparison between a legacy DWRR arbiter and an enhanced DWRR arbiter for a given situation. FIG. 3A illustrates a table representing an example situation for a comparison between a legacy DWRR arbiter and an enhanced DWRR arbiter. Each of four requesters, indexed 0, 1, 2, and 3, has a packet queue, in which zero or more packets to transmit exist. In the example illustrated in FIG. 3A, requester 0 has three packets in the queue at the beginning, the size of the packets are 3, 3, and 2. The weight for requester 0 is 10. Requester 1 has two packets in the queue at the beginning, the size of which are 5 and 6. The weight for requester 1 is 16. Requester 2 has two packets in the queue at the beginning, the size of each is 7. The weight for Requester 3 is 14. Requester 3 has an empty queue. The weight for requester 3 is 1. While the table in FIG. 3A shows the status of the packet queues, more packets may arrive later.

FIG. 3B illustrates an example behavior of a legacy DWRR arbiter for the given situation. The credit counter for each requester is assumed to be reset to the corresponding weight. Initially, the arbiter schedules all three packets of requester 0 because the required credits 8 for the three packets are less than the initial credits 10 available at the credit counter associated with requester 0. The arbiter updates the credit counter associated with requester 0 to 2 after transmitting all three packets. In the example illustrated in FIGS. 3A-3C, more packets arrive to requester 0 after the three packets are scheduled. The arbiter moves to requester 1 after finishing requester 0. The arbiter schedules both packets in the queue for requester 1. The arbiter updates the credit counter associated with requester 1 to 6 by subtracting 11 from 16, the initial credits. More packets arrive to requester 1 after the two packets are scheduled. The arbiter moves to requester 2 after finishing requester 1. The arbiter schedules both packets in the queue for requester 2. The arbiter updates the credit counter associated with requester 2 to 0 by subtracting 14, credits required for the two packets, from 14, the initial credits. The arbiter skips scheduling for requester 3 because the queue associated with requester 3 is empty. The arbiter replenishes the credit counters for the requesters after going through all the requesters once. After the replenishments, the credit counter associated with requester 0 becomes 12 because more packets have arrived between the scheduling of previous packets and the replenishments. The credit counter associated with requester 1 becomes 22 because more packets have arrived between the scheduling of previous packets and the replenishments. The credit counter associated with requester 2 becomes 14 because more packets have arrived between the scheduling of previous packets and the replenishments. The credit counter associated with requester 3 becomes 0 because the queue associated with requester 3 is empty.

FIG. 3C illustrates an example behavior of an enhanced DWRR arbiter for the given situation. As in FIG. 3B, the credit counter for each requester is assumed to be reset to the corresponding weight. The arbiter 220 determines whether requester 0 satisfies the conditions. The arbiter 220 schedules the first packet, size of 3, from the queue associated with requester 0. The arbiter 220 updates the credit counter value associated with requester 0 to 7. The arbiter 220 moves to requester 1. The arbiter 220 determines whether requester 1 satisfies the conditions. As requester 1 satisfies the conditions, the arbiter 220 schedules the first packet, size of 5, from the queue associated with requester 1. The arbiter 220 updates the credit counter value associated with requester 1 to 11. The arbiter 220 moves to requester 2. The arbiter 220 determines whether requester 2 satisfies the conditions. As requester 2 satisfies the conditions, the arbiter 220 schedules the first packet, size of 7, from the queue associated with requester 2. The arbiter 220 updates the credit counter value associated with requester 2 to 7. The arbiter 220 moves to requester 3. The arbiter 220 determines whether requester 3 satisfies the conditions. As the queue associated with requester 3 is empty, requester 3 fails to satisfy the conditions. The arbiter 220 moves back to requester 0. The arbiter 220 determines whether requester 0 satisfies the conditions. Because requester 0 satisfies the conditions, the arbiter 220 schedules the second packet, size of 3, from the queue associated with requester 0. The arbiter 220 updates the credit counter value associated with requester 0 to 4. The arbiter 220 moves to requester 1. The arbiter 220 determines whether requester 1 satisfies the conditions. As requester 1 satisfies the conditions, the arbiter 220 schedules the second packet, size of 6, from the queue associated with requester 1. The arbiter 220 updates the credit counter value associated with requester 1 to 5. The arbiter 220 moves to requester 2. The arbiter 220 determines whether requester 2 satisfies the conditions. As requester 2 satisfies the conditions, the arbiter 220 schedules the second packet, size of 7, from the queue associated with requester 2. The arbiter 220 updates the credit counter value associated with requester 2 to 0. The arbiter 220 moves to requester 3. The arbiter 220 determines whether requester 3 satisfies the conditions. As the queue associated with requester 3 is empty, requester 3 fails to satisfy the conditions. The arbiter 220 moves back to requester 0. The arbiter 220 determines whether requester 0 satisfies the conditions. Because requester 0 satisfies the conditions, the arbiter 220 schedules the third packet, size of 2, from the queue associated with requester 0. The arbiter 220 updates the credit counter value associated with requester 0 to 2. The arbiter 220 moves to requester 1. At least two packets, size of each is 2, have arrived at the queue associated with requester 1 since the beginning of the iteration. The arbiter 220 determines whether requester 1 satisfies the conditions. As requester 1 satisfies the conditions, the arbiter 220 schedules the recently arrived third packet, size of 2, from the queue associated with requester 1. The arbiter 220 updates the credit counter value associated with requester 1 to 3. The arbiter 220 moves to requester 2. At least one packet, size of which is 7, has arrived at the queue associated with requester 2 since the beginning of the iteration. The arbiter 220 determines whether requester 2 satisfies the conditions. As the credit counter value for requester 2 is 0, requester 2 fails to satisfy the conditions. The arbiter 220 moves to requester 3. The arbiter 220 determines whether requester 3 satisfies the conditions. As the queue associated with requester 3 is empty, requester 3 fails to satisfy the conditions. The arbiter 220 moves back to requester 0. At least two packets, size of each is 2, has arrived at the queue associated with requester 0 since the beginning of the iteration. The arbiter 220 determines whether requester 0 satisfies the conditions. Because requester 0 satisfies the conditions, the arbiter 220 schedules the recently arrived fourth packet, size of 2, from the queue associated with requester 0. The arbiter 220 updates the credit counter value associated with requester 0 to 0. The arbiter 220 moves to requester 1. The arbiter 220 determines whether requester 1 satisfies the conditions. As requester 1 satisfies the conditions, the arbiter 220 schedules the recently arrived fourth packet, size of 2, from the queue associated with requester 1. The arbiter 220 updates the credit counter value associated with requester 1 to 1. Now, the arbiter 220 may determine that none of the requesters can satisfy the conditions. The arbiter 220 replenish the credit counters. After replenishments, the credit counter associated with requester 0 becomes 10. The credit counter associated with requester 1 becomes 17 because the queue associated with requester 1 is not empty. The credit counter associated with requester 2 becomes 14. The credit counter associated with requester 3 becomes 1 even though the queue associated with requester 3 is empty.

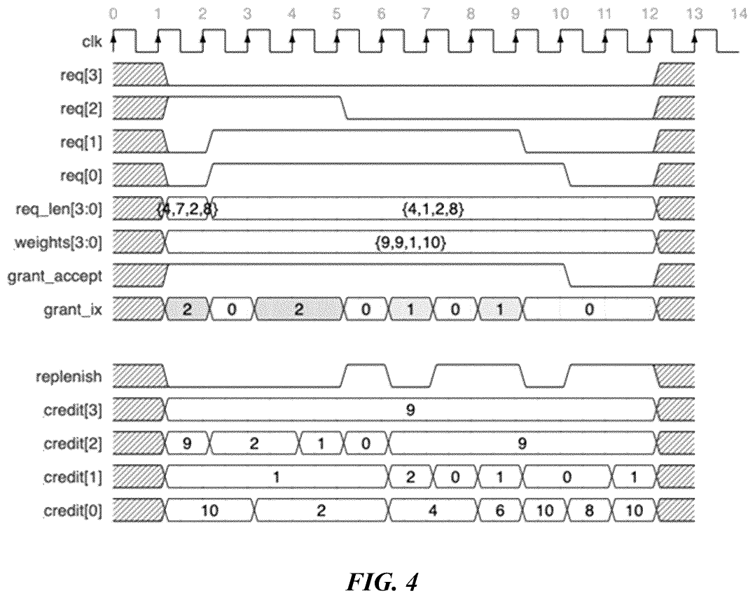

FIG. 4 illustrates an example behavior of an enhanced DWRR arbiter in detail. In the example illustrated in FIG. 4, requesters 0, 1, 2, and 3, denoted as req[0], req[1], req[2], and req[3], are associated with weights 10, 1, 9, and 9, respectively. The weights are indicated as weights[3:0]. A credit counter for each requester, denoted as credit[0], credit[1], credit[2], and credit[3], is assumed to be set with a corresponding weight at a beginning of cycle 1. At cycle 1, req[2] is the only requestor with an active request. The size of the request is 7. The value of credit[2] is 9. As req[2] satisfies the conditions, the request from req[2] is scheduled by the arbiter 220. The arbiter 220 updates credit[2] to 2. The arbiter 220 moves to req[3]. At cycle 2, req[0], req[1], and req[2] have active requests. Sizes of those requests are 8, 2, and 1 as indicated by req_len[3:0]. Since req[3] does not have an active request, the arbiter 220 moves to req[0]. credit[0] is 10 and req_len[0] is 8. Thus, req[0] satisfies the conditions. The arbiter 220 schedules the request at the head of the queue. The arbiter 220 updates credit[0] to 2. The arbiter 220 moves to req[1]. At cycle 3, the arbiter 220 determines whether req[1] satisfies the conditions. req[1] fails to satisfy the conditions because credit[1] is 1 and req_len[1] is 2. The arbiter 220 moves to req[2]. req[2] satisfies the conditions because credit[2] is 2 and req_len[2] is 1. The arbiter 220 schedule the request from req[2]. The arbiter 220 update credit[2] to 1. At cycle 4, req[3], req[0], and req[1] fail to satisfy the conditions. As req[2] satisfies the conditions, the arbiter 220 schedules a request from req[2]. The arbiter updates credit[2] to 0. The queue associated with req[2] becomes empty. Thus, req[2] does not have an active request. At cycle 5, the arbiter 220 determines that none of the requesters can satisfies the conditions. Thus, the arbiter 220 replenish the credit counters. credit[0] is replenished to 12. credit[1] is replenished to 2. credit[2] is replenished to 9. credit[3] remains same at 9. The arbiter 220 determines whether req[0] satisfies the conditions. credit[0] is 12 and req_len[0] is 8. Because req[0] satisfies the conditions, the arbiter 220 schedules a request from req[0]. The arbiter 220 updates credit[0] to 4. At cycle 6, a request from req[1] is scheduled. The arbiter updates credit[1] to 0. At cycle 7, the arbiter 220 replenishes the credit counters: credit[0] to 14, credit[1] to 1, credit[2] stays at 9, and credit[3] stays at 9. The arbiter 220 schedules a request from req[0] as credit[0] is 14 and req_len[0] is 8. The arbiter 220 updates credit[0] to 6. at cycle 8, the arbiter 220 determines that no request satisfies the conditions. The arbiter 220 replenishes the credit counters: credit[0] to 16, credit[1] to 2, credit[2] stays at 9, and credit[3] stays at 9. After the replenishments, the arbiter 220 determines that req[1] satisfies the conditions because credit[1] is 2 and req_len[1] is 2. The arbiter 220 schedule the request from req[1]. The arbiter 220 updates credit[1] to 0. The queue associated with req[1] is empty. Thus, req[1] does not have an active request. At cycle 9, the arbiter 220 determines that req[0] satisfies the conditions as credit[0] is 16 and req_len[0] is 8. The arbiter 220 schedules a request from req[0]. The arbiter 220 updates credit[0] to 8. At cycle 10, the arbiter 220 replenishes the credit counters again: credit[0] to 18, credit[1] to 1, credit[2] stays at 9, and credit[3] stays at 9. After replenishments, the arbiter 220 determines that req[0] satisfies the conditions as credit[0] is 18 and req_len[0] is 8. The arbiter 220 schedules a request from req[0]. The arbiter 220 updates credit[0] to 10.

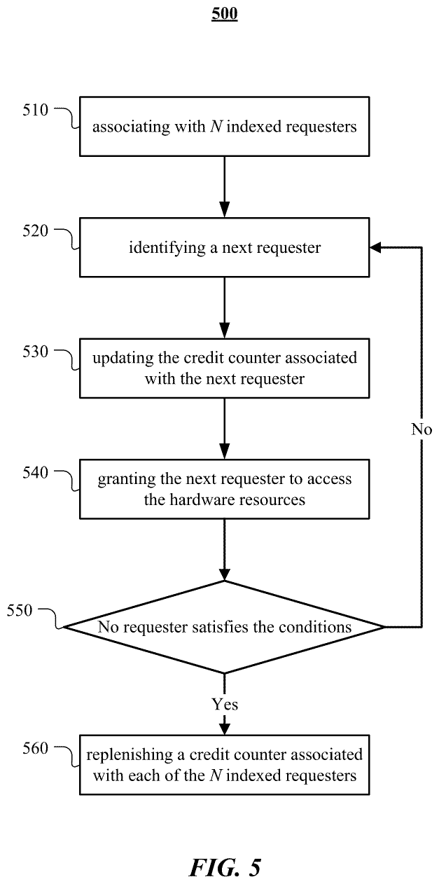

FIG. 5 illustrates an example method 500 for scheduling hardware accesses between a plurality of competing requesters. The method may begin at step 510, where an arbiter associated with hardware resources of a computing system may associate with N indexed requesters requesting accesses to the hardware resources. Each of the N indexed requesters may be associated with a credit counter and a weight. The method may continue to grant a right to access the hardware resources to each requester that satisfies conditions in an indexing order among the N indexed requesters. Granting the right to access the hardware resources to each requester that satisfies conditions in an indexing order among the N indexed requesters comprises step 520 through step 540. At step 520, the arbiter may identify a next requester that has an access request to the hardware resource at a head of a queue associated with the next requester. At step 530, the arbiter may update the credit counter associated with the next requester. At step 540, the arbiter may grant the next requester to access the hardware resources for a number of credits associated with the access request. At step 550, the arbiter may determine that none of the N indexed requesters satisfies the conditions. At step 560, the arbiter replenish, upon a determination that none of the N indexed requesters satisfies the conditions, a credit counter associated with each of the N indexed requesters. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for scheduling hardware accesses between a plurality of competing requesters including the particular steps of the method of FIG. 5, this disclosure contemplates any suitable method for scheduling hardware accesses between a plurality of competing requesters including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Systems and Methods

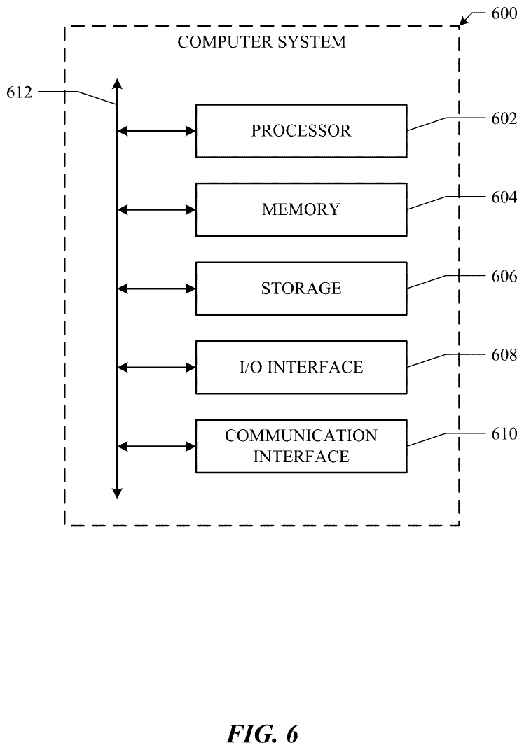

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by an arbiter associated with hardware resources of a computing system:
associating with N indexed requesters requesting accesses to the hardware resources, wherein each of the N indexed requesters is associated with a credit counter and a weight;
repeatedly granting a right to access the hardware resources to each requester that satisfies conditions in an indexing order among the N indexed requesters until none of the N indexed requesters satisfies the conditions by:
identifying a next requester that has an access request to the hardware resource at a head of a queue associated with the next requester;
updating the credit counter associated with the next requester;
granting the next requester to access the hardware resources for a number of credits associated with the access request; and
replenishing, upon a determination that none of the N indexed requesters satisfies the conditions, a credit counter associated with each of the N indexed requesters.

2. The method of claim 1, wherein the conditions comprise:
(1) the requester has an access request requiring a first number of credits at a head of a queue associated with the requester; and
(2) a second number of credits available at a credit counter associated with the requester is greater or equal to the first number of credits.

3. The method of claim 2, wherein updating the credit counter associated with the next requester comprises subtracting the first number from the second number.

4. The method of claim 1, wherein identifying the next requester comprises:
repeating following steps until a requester corresponding to a current index value satisfies the conditions:
updating the current index value; and
determining whether a requester corresponding to the current index value satisfies the conditions.

5. The method of claim 4, wherein updating the current index value comprises increasing the current index value by one.

6. The method of claim 5, wherein updating the current index value further comprises:
determining that the current index value is greater than an index value corresponding to a last indexed requester among the N indexed requesters; and
resetting, in response to the determination, the current index value to an index value corresponding to a first indexed requester among the N indexed requesters.

7. The method of claim 1, wherein replenishing a credit counter associated with a requester comprises:
determining that the requester has one or more access requests in a queue associated with the requester; and
adding the weight corresponding to the requester to the credit counter.

8. The method of claim 1, wherein replenishing a credit counter associated with a requester comprises:
determining that the requester has zero access request in a queue associated with the requester; and
resetting the credit counter to the weight corresponding to the requester.

9. One or more computer-readable non-transitory storage media embodying software that is operable when executed, by an arbiter associated with hardware resources of a computing system, to:
associate with N indexed requesters requesting accesses to the hardware resources, wherein each of the N indexed requesters is associated with a credit counter and a weight;
repeatedly grant a right to access the hardware resources to each requester that satisfies conditions in an indexing order among the N indexed requesters until none of the N indexed requesters satisfies the conditions by:
identify a next requester that has an access request to the hardware resource at a head of a queue associated with the next requester;
update the credit counter associated with the next requester;
grant the next requester to access the hardware resources for a number of credits associated with the access request; and
replenish, upon a determination that none of the N indexed requesters satisfies the conditions, a credit counter associated with each of the N indexed requesters.

10. The media of claim 9, wherein the conditions comprise:
(1) the requester has an access request requiring a first number of credits at a head of a queue associated with the requester; and
(2) a second number of credits available at a credit counter associated with the requester is greater or equal to the first number of credits.

11. The media of claim 10, wherein updating the credit counter associated with the next requester comprises subtracting the first number from the second number.

12. The media of claim 9, wherein identifying the next requester comprises:
repeating following steps until a requester corresponding to a current index value satisfies the conditions:
updating the current index value; and
determining whether a requester corresponding to the current index value satisfies the conditions.

13. The media of claim 12, wherein updating the current index value comprises increasing the current index value by one.

14. The media of claim 13, wherein updating the current index value further comprises:
determining that the current index value is greater than an index value corresponding to a last indexed requester among the N indexed requesters; and
resetting, in response to the determination, the current index value to an index value corresponding to a first indexed requester among the N indexed requesters.

15. The media of claim 9, wherein replenishing a credit counter associated with a requester comprises:
determining that the requester has one or more access requests in a queue associated with the requester; and
adding the weight corresponding to the requester to the credit counter.

16. The media of claim 9, wherein replenishing a credit counter associated with a requester comprises:
determining that the requester has zero access request in a queue associated with the requester; and
resetting the credit counter to the weight corresponding to the requester.

17. A computing system comprising:
one or more processors;
an arbiter associated with hardware resources of the computing system; and
one or more computer-readable non-transitory storage media coupled to the arbiter and comprising instructions operable when executed by the arbiter to cause the system to:
associate with N indexed requesters requesting accesses to the hardware resources, wherein each of the N indexed requesters is associated with a credit counter and a weight;
repeatedly grant a right to access the hardware resources to each requester that satisfies conditions in an indexing order among the N indexed requesters until none of the N indexed requesters satisfies the conditions by:
identify a next requester that has an access request to the hardware resource at a head of a queue associated with the next requester;
update the credit counter associated with the next requester;
grant the next requester to access the hardware resources for a number of credits associated with the access request; and
replenish, upon a determination that none of the N indexed requesters satisfies the conditions, a credit counter associated with each of the N indexed requesters.

18. The system of claim 17, wherein the conditions comprise:
(1) the requester has an access request requiring a first number of credits at a head of a queue associated with the requester; and
(2) a second number of credits available at a credit counter associated with the requester is greater or equal to the first number of credits.

19. The system of claim 18, wherein updating the credit counter associated with the next requester comprises subtracting the first number from the second number.

20. The system of claim 17, wherein identifying the next requester comprises:
repeating following steps until a requester corresponding to a current index value satisfies the conditions:
updating the current index value; and
determining whether a requester corresponding to the current index value satisfies the conditions.
